(19) United States
(12) Patent Application Publication
(10) Pub. No.: US 2022/0338677 A1
(43) Pub. Date: Oct. 27, 2022

(54) Combination Shredder and Container

(71) Applicant: Liran Luger, Concord, CA (US)

(72) Inventor: Liran Luger, Concord, CA (US)

(21) Appl. No.: 17/302,022

(22) Filed: Apr. 21, 2021

(51) Int. Cl. A47J 42/34; B65D 50/04; A47J 42/50

(52) U.S. Cl. CPC A47J 42/34; B65D 50/043; A47J 42/50; B65D 2215/02

(57) ABSTRACT

A combination shredder and container for cannabis where a cap assembly is threadably attached to an open topped container. The cap assembly includes an outer cap whose top surface has a plurality of apertures and downwardly directed pyramid shaped shredding members and an inner cap having upwardly directed pyramid shaped members. The inner cap remains stationary during the shredding process, and the outer cap rotates about the inner cap causing the pyramid shaped shredding members to pass in close proximity to each other and causing the cannabis contained within the container and cap assembly to be shredded and to exit the apertures of the outer cap.

### CROSS REFERENCE TO RELATED APPLICATIONS

Not Applicable.

### STATEMENT REGARDING FEDERALLY SPONSORED RESEARCH OR DEVELOPMENT

Not Applicable

### DESCRIPTION OF ATTACHED APPENDIX

Not Applicable.

### BACKGROUND OF THE INVENTION

This invention relates generally to the field of combination container and dispensing devices and more specifically to a container having a shredder mechanism built into the cap of the container.

### BRIEF SUMMARY OF THE INSTANT INVENTION

The primary object of the invention is to provide combination shredder and container where a user can remove an air tight lid and dispense shredded cannabis product through a plurality of apertures in the cap by turning the outer portion of the cap.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a combination shredder and container for cannabis including an open topped container having a male threaded aperture and a child proof tab, a cap assembly including a top lid, a lid gasket, an outer ring having an upper integral cover plate, the cover plate having a plurality of apertures, the underside of the cover plate having downwardly facing pyramid shredding members, a secondary gasket, a cylindrically shaped inner cap, the inner cap including female threads that can engage the male threads of the container, the inner cap including a cover plate having plurality of upwardly directed pyramid shaped shredding members that are in close proximity to the pyramid shaped shredding members of the outer ring cover plate, the inner cap assembly including downwardly faced tabs that can engage indentations in the perimeter of the container causing the inner cap to remain stationary while the outer cap can be rotated by a user causing the upper and lower shredding pyramid members to pass by each other in close proximity creating a shredding action to the cannabis within the container which then can exit the apertures in the outer cap cover plate.

### BRIEF DESCRIPTION OF THE DRAWINGS

The drawings constitute a part of this specification and include exemplary embodiments to the instant invention, which may be embodied in various forms. It is to be understood that in some instances various aspects of the instant embodiments may be shown exaggerated or enlarged to facilitate an understanding of the instant embodiment.

FIG. 1 is a perspective view of the embodiment.

FIG. 2 is an exploded view of the embodiment.

FIG. 3 is a side section view of the embodiment.

FIG. 4 is a perspective view of the embodiment with the top lid removed.

FIG. 5 is an underside view of the outer and inner cap.

FIG. 6 is a section view of the outer and inner cap.

FIG. 7 is a section view of the container attached to the outer and inner cap.

FIG. 8 is a partial perspective view showing the outer cap to inner cap retaining method.

FIG. 9 is a partial perspective view showing the child lock mechanism.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

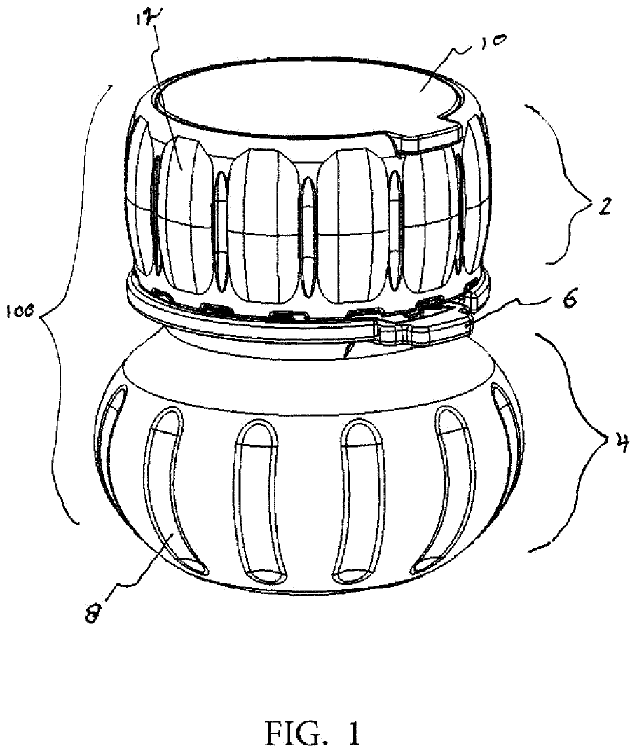

Referring now to FIG. 1 we see a perspective view of the embodiment 100. A container 4 is threadably attached to a cap 2 that includes a shredder assembly as shown in Figures below. A top lid 10 covers apertures 22 shown in Figures below. Child proof tab 6, as is found in many drug bottles, must be pressed down in order to unscrew the cap 2. The cap 2 contains perimeter ribs 12, and container 4 contains indentations 8 that allow the user to have a firm grip on both the cap 2 and the container 4 during the clockwise and counter clockwise turning action that causes shredding of cannabis as will be described below.

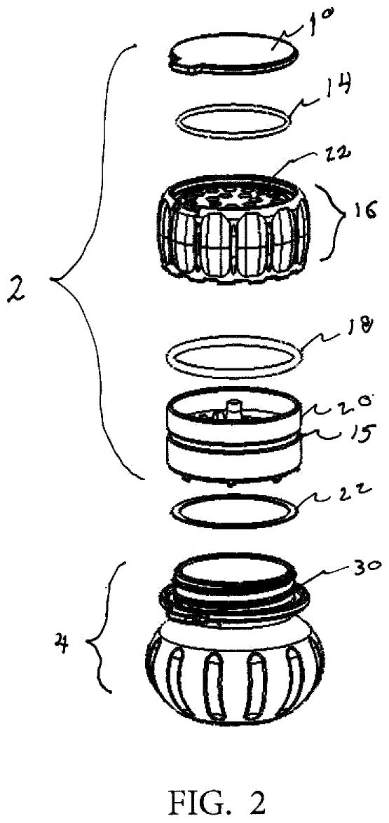

FIG. 2 is an exploded view of the embodiment 100. Top lid 10 covers the apertures 22 located on the top surface of outer cap 16. Gasket 14 ensures that the gap between the top lid 10 and top surface of the outer cap 16 is air tight. Inner cap 20 is held within the outer cap 16 and is made air tight by gasket 14 which resides in recess 15. Gasket 22 is installed between the bottom of cap assembly 2 and container 4. Male threads 30 can engage mating threads located on the inner perimeter of inner cap 20.

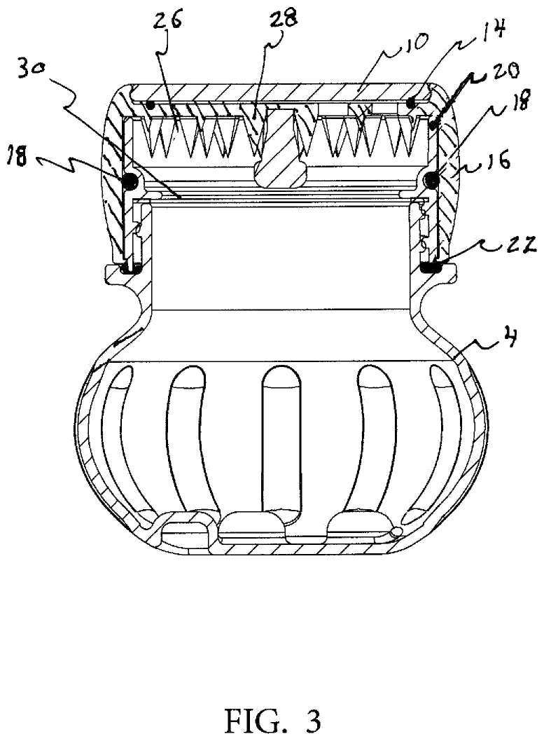

FIG. 3 is a side section view of the embodiment 100. Inverted pyramid members 28 are integrally attached to the underside of outer cap 16. Pyramid members 26 are integrally attached to the top surface of inner cap 20. The close proximity of pyramid members 28 to pyramid members 26 causes a shredding action when outer cap 16 is rotated while inner cap 20 remains stationary.

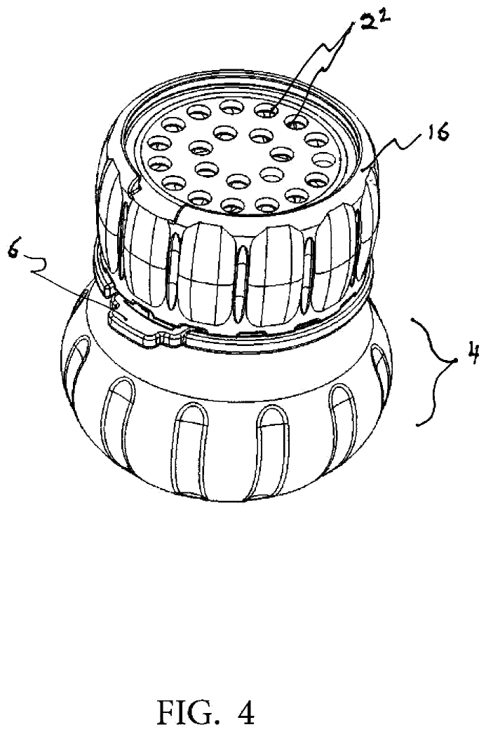

FIG. 4 is a perspective view of the invention clearly showing apertures 22 located on the cover plate of outer cap 16. The Shredded cannabis exits from these apertures when the user twists the outer cap clockwise and counter clockwise alternately.

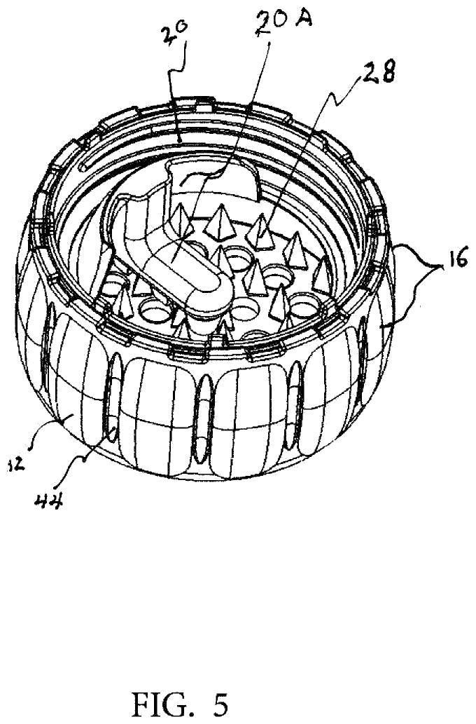

FIG. 5 is a perspective view of the outer cap 16 and inner cap 20. A cannabis director plate 20A helps push the cannabis into the central portion of the cap thereby ensuring that the cannabis has maximum exposure to pyramid members 28 during use. However, this director plate 20A is an optional component in the construction of the shredder and bottle described in the instant embodiment 100. Outer ribs 12 and indentations 44 allow the user to have a non-slip grip on the outer cap 16 as he or she rotates the cap 16 during use.

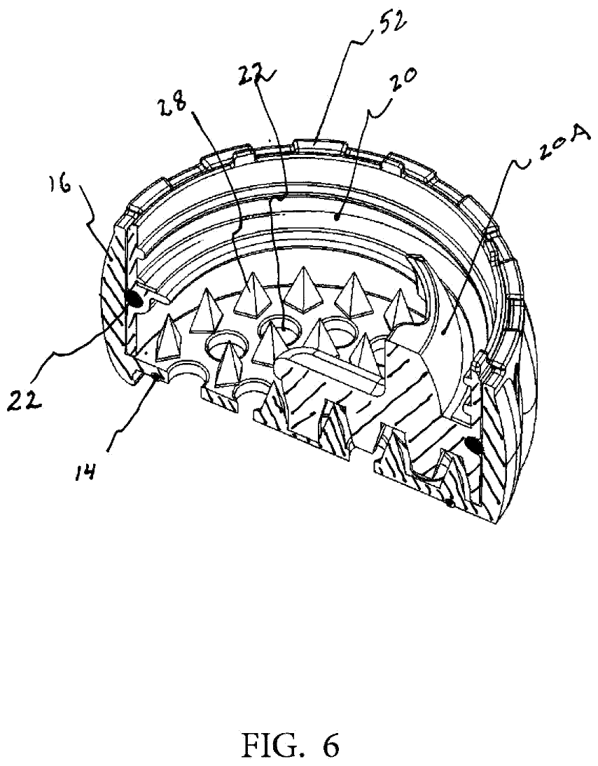

FIG. 6 is a section view of the cap 2 clearly showing the director plate 20A, apertures 22 and pyramid members 28.

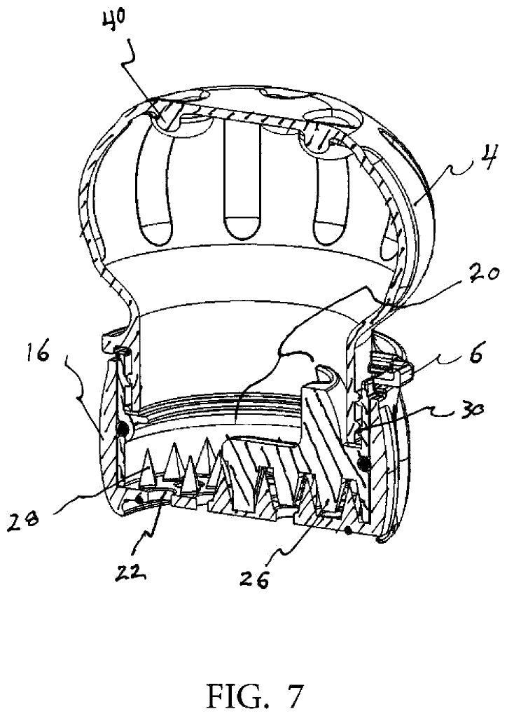

FIG. 7 is a side section view of the entire embodiment 100 in the upside-down position which is how it is oriented when the user wishes to shred cannabis and have it exit apertures 22. In this orientation, cannabis stored in container 4 is fed down via gravity to inner cap 20. Pyramid members 26, 28 shred the cannabis as outer cap 16 is turned. Bumps 40 in container 4 prevent cannabis from attaching to side walls and bottom of container 4 during storage.

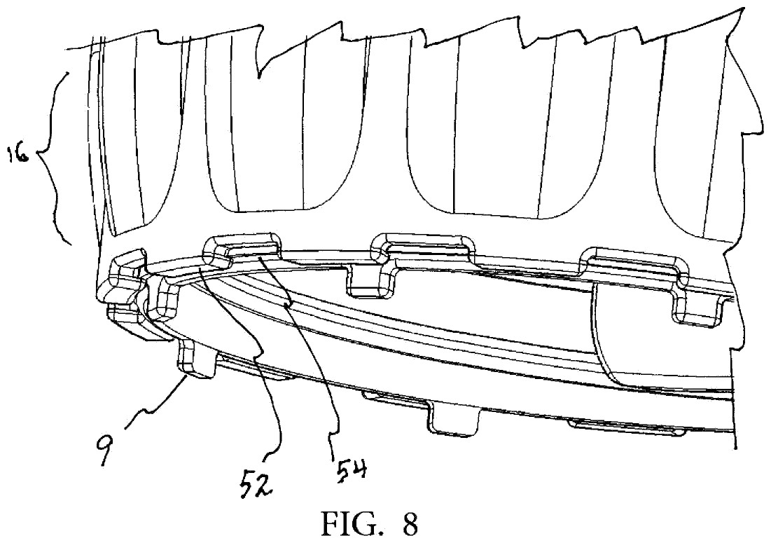

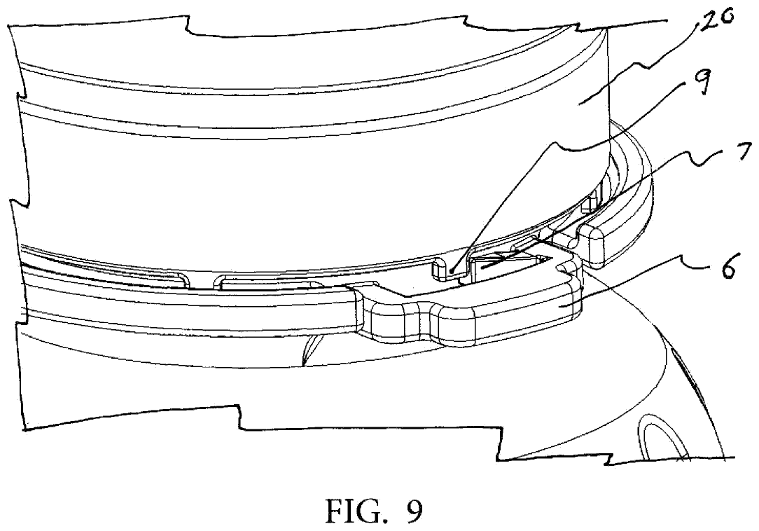

FIG. 8 is a partial perspective view showing outer cap 16 rotatably retained by inwardly directed flanges 52 engaging the lower ledge 54 of the inner cap 20. The flanges 52 allow the outer cap 16 to rotate while preventing the outer cap 16 from completely disengaging from the inner cap 20. Downward facing tabs 9 can engage release tab 6 as shown in FIG. 9.

In the preferred embodiment, the container 4 is blow molded from an opaque blow molded plastic, and the cap assembly 2 is injection molded from polycarbonate plastic.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

In the claims, the word ‘comprising’ does not exclude the presence of other elements or steps then those listed in a claim. Furthermore, the terms “a” or “an,” as used herein, are defined as “one, or more than one.” Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

What is claimed is:

1. A device combining a shredder and a container to store, shred and enable discharge of shredded cannabis or similar dry material, comprising:
a hollow spherical frustum container chamber member comprised of a spherical side wall comprising an inner surface and an outer perimeter, a closed bottom and an open top aperture comprising a radial threaded collar;
a rotatable spherical frustum outer cap member comprising a spherical side wall, the cap member further comprising:
an upper integral cover plate disposed in a plane parallel to the container bottom comprising a plurality of apertures, further comprising a plurality of pyramid shaped members facing the container;
a top lid disposed in a plane parallel to the container member bottom;
a lid gasket disposed between the top lid and the upper integral cover plate;
the outer cap member being rotatably retained by a plurality of inwardly directed flanges engaging a stationary inner cap ledge, allowing the outer cap to rotate while preventing the outer cap from disengaging from the stationary inner cap;
a secondary gasket surrounding a cylindrically shaped stationary inner cap comprising a plurality of pyramid shaped members facing the cover plate disposed in close proximity to the cover plate pyramid shaped members; and
wherein the shredding of the cannabis is accomplished by the pyramid shaped members when rotating the outer cap with relation to the stationary inner cap.

2. A device combining a shredder and a container of claim 1 further comprising a childproof tab disposed on the radial threaded collar of the container chamber, wherein the childproof tab must be pushed down to allow the cap to be threadably disengaged from the container chamber.

3. A device combining a shredder and a container of claim 1 wherein: the hollow spherical frustum container chamber member further comprises a plurality of ribs projecting outwardly disposed on the outer perimeter of the container chamber; the cap member further comprises a plurality of indentations disposed on the outer perimeter of the cap, wherein the plurality of the ribs and the plurality of indentations facilitate a user to have a firm grip on both, the outer cap member and the container member when rotating the outer cap during the shredding process.

4. A device combining a shredder and a container of claim 1 wherein a plurality of inwardly directed bumps on the inner surface of the container prevent cannabis stored on the container from sticking to the walls of the container.

5. A device combining a shredder and a container of claim 1 wherein the inner cap includes a partial funnel shape to help direct cannabis into the pyramid shaped members for more efficient shredding.

6. A device combining a shredder and a container of claim 1 wherein when the cap member and the container member are turned with the cap lid being pointed down, the cannabis contained within the container member can fall down via gravity into the inner cap where it can be shaken out via the plurality of the apertures of the upper integral cover plate.

7. A device combining a shredder and a container of claim 1 wherein the container is made of opaque blow molded plastic and the cap member is made of injection molded polycarbonate.
